(19) United States
(12) Patent Application Publication
(10) Pub. No.: US 2012/0314590 A1
(43) Pub. Date: Dec. 13, 2012

(54) ENHANCED PRECODING FEEDBACK FOR MULTIPLE-USER MULTIPLE-INPUT AND MULTIPLE-OUTPUT (MIMO)

(75) Inventors: Sayantan Choudhury, Berkeley, CA (US); Zhanping Yin, Vancouver, WA (US); Ahmad Khoshnevis, Portland, OR (US); Shohei Yamada, Camas, WA (US)

(73) Assignee: Sharp Laboratories of America, Inc., Camas, WA (US)

(21) Appl. No.: 13/158,040

(22) Filed: Jun. 10, 2011

(51) Int. Cl. H04W 24/00; H04W 92/00

(52) U.S. Cl. 370/252; 370/310

(57) ABSTRACT

A method for reporting uplink control information (UCI) on a user equipment (UE) is described. A first precoding matrix indicator (PMI) corresponding to a multiple-user multiple-input and multiple-output (MU-MIMO) downlink transmission is generated using a first codebook set. A second PMI corresponding to the MU-MIMO downlink transmission is generated using a second codebook set. The first PMI and the second PMI are sent to an eNode B in a channel state information (CSI) report.

### TECHNICAL FIELD

The present invention relates generally to wireless communications and wireless communications-related technology. More specifically, the present invention relates to systems and methods for enhanced precoding feedback for multiple-user multiple-input and multiple-output (MIMO).

### BACKGROUND

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of cells, each of which may be serviced by a base station. A base station may be a fixed station that communicates with mobile stations.

Various signal processing techniques may be used in wireless communication systems to improve both the efficiency and quality of wireless communications. For example, a wireless communication device may report uplink control information (UCI) to a base station. This uplink control information (UCI) may be used by the base station to select appropriate transmission modes, transmission schemes and modulation and coding schemes for downlink transmissions to the wireless communication device.

Benefits may be realized by improved methods for reporting uplink control information (UCI) by a wireless communication device.

### BRIEF DESCRIPTION OF THE DRAWINGS

FIG. 1 is a block diagram illustrating a wireless communication system using uplink control information (UCI) multiplexing;

FIG. 2 is a block diagram illustrating a wireless communication system using uplink control information (UCI) multiplexing;

FIG. 3 is a block diagram illustrating the layers used by a user equipment (UE);

FIG. 4 is a block diagram illustrating examples of channel state information (CSI) content of uplink control information (UCI);

FIG. 5 is a flow diagram of a method for reporting uplink control information (UCI);

FIG. 6 is a flow diagram of another method for reporting uplink control information (UCI);

FIG. 7 is a flow diagram of method for reducing the number of feedback bits in uplink control information (UCI) using joint encoding;

FIG. 8 is a flow diagram of a method for reducing the number of feedback bits in uplink control information (UCI) using enhanced channel quality indicator (CQI) feedback for multiple-user multiple-input and multiple-output (MU-MIMO);

FIG. 9 illustrates various components that may be utilized in a user equipment (UE); and

FIG. 10 illustrates various components that may be utilized in an eNode B.

### DETAILED DESCRIPTION

A method for reporting uplink control information (UCI) on a user equipment (UE) is disclosed. The method includes generating a first precoding matrix indicator (PMI) corresponding to a multiple-user multiple-input and multiple-output (MU-MIMO) downlink transmission using a first codebook set. The method also includes generating a second PMI corresponding to the MU-MIMO downlink transmission using a second codebook set. The method further includes sending the first PMI and the second PMI to an eNode B in a channel state information (CSI) report. The method may also include receiving the MU-MIMO downlink transmission from the eNode B.

The second PMI may use less feedback bits than the first PMI. The first PMI and the second PMI may be orthogonal to each other. The first codebook set and the second codebook set may be orthogonal to each other.

The method may also include determining a number of bits used in the first PMI. The method may further include determining a second codebook set that uses less bits than the number of bits used in the first PMI.

The method may also include joint encoding the first PMI and the second PMI using a lookup table. Sending the first PMI and the second PMI to an eNode B in a CSI report may include sending the joint encoded PMI to the eNode B. A row entity in the lookup table may correspond to the first PMI and a column entity in the lookup table may correspond to the second PMI.

The method may also include selecting a first channel quality indicator (CQI) index corresponding to the first PMI. The method may further include selecting a second CQI index corresponding to the second PMI with a lower value than the first CQI index. Sending the first PMI and the second PMI to an eNode B in a CSI report may include sending the first CQI index and the second CQI index to the eNode B. The second CQI index may be represented with a smaller number of bits than the first CQI index using partitioning.

A user equipment (UE) configured for reporting uplink control information (UCI) is also disclosed. The UE includes a processor and instructions stored in memory that is in electronic communication with the processor. The UE generates a first precoding matrix indicator (PMI) corresponding to a multiple-user multiple-input and multiple-output (MU-MIMO) downlink transmission using a first codebook set. The UE also generates a second PMI corresponding to the MU-MIMO downlink transmission using a second codebook set. The UE further sends the first PMI and the second PMI to an eNode B in a channel state information (CSI) report.

The 3rd Generation Partnership Project, also referred to as “3GPP,” is a collaboration agreement that aims to define globally applicable technical specifications and technical reports for third and fourth generation wireless communication systems. The 3GPP may define specifications for the next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE and LTE-Advanced standards (e.g., Release-8, Release-9 and Release-10). However, the scope of the present disclosure should not be limited in this regard. At least some aspects of the systems and methods disclosed herein may be utilized in other types of wireless communication systems.

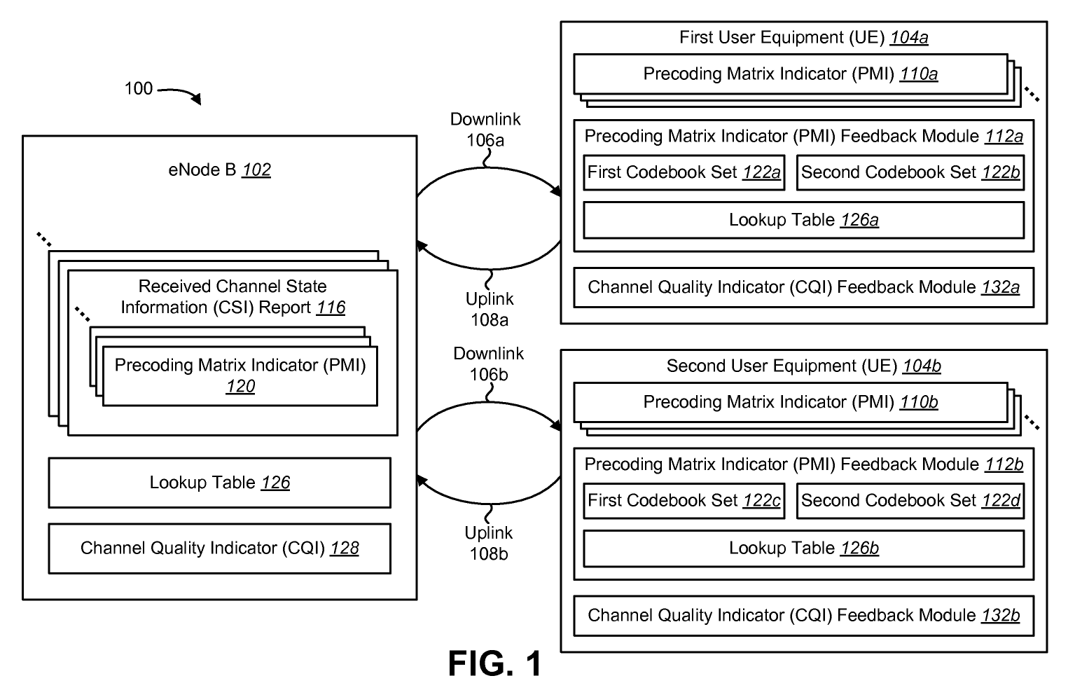

FIG. 1 is a block diagram illustrating a wireless communication system 100 that utilizes multiple-user multiple-input and multiple-output (MU-MIMO). The wireless communication system 100 may include an eNode B 102 in communication with multiple user equipments (UEs) 104. An eNode B 102 may be referred to as an access point, a Node B, a base station or some other terminology. Likewise, a user equipment (UE) 104 may be referred to as a mobile station, a subscriber station, an access terminal, a remote station, a user terminal, a terminal, a handset, a subscriber unit, a wireless communication device or some other terminology.

Communication between a user equipment (UE) 104 and an eNode B 102 may be accomplished using transmissions over a wireless link, including an uplink 108a-b and a downlink 106a-b. The uplink 108 refers to communications sent from a user equipment (UE) 104 to an eNode B 102. The downlink 106 refers to communications sent from an eNode B 102 to a user equipment (UE) 104.

In general, the communication link may be established using a single-input and single-output (SISO), multiple-input and single-output (MISO), single-input and multiple-output (SIMO) or a multiple-input and multiple-output (MIMO) system. A MIMO system may include both a transmitter and a receiver equipped with multiple transmit and receive antennas. Thus, an eNode B 102 may have multiple antennas and a user equipment (UE) 104 may have multiple antennas. In this way, an eNode B 102 and a user equipment (UE) 104 may each operate as either a transmitter or a receiver in a MIMO system. One benefit of a MIMO system is improved performance if the additional dimensionalities created by the multiple transmit and receive antennas are utilized.

Multiple-user multiple-input and multiple-output (MU-MIMO) may increase user throughputs on the downlink over traditional single-user multiple-input and multiple-output (SU-MIMO) by making more intelligent use of the eNode B 102 resources. In other words, multiple-user multiple-input and multiple-output (MU-MIMO) may allow the eNode B 102 to transmit a signal to multiple user equipments (UEs) 104a-b in the same band simultaneously. Multiple-user multiple-input and multiple-output (MU-MIMO) is thus an extension of MIMO. By utilizing multiple-user multiple-input and multiple-output (MU-MIMO) in the wireless communication system 100, performance enhancements may be obtained.

In 3GPP LTE Release 8 and LTE-Advanced, a channel state information (CSI) report 116 that includes a channel quality indicator (CQI), a precoding matrix indicator (PMI) 110a-b and a rank indication (RI) is reported by a user equipment (UE) 104 to the eNode B 102 to assist the eNode B 102 in selecting an appropriate transmission mode, transmission scheme (e.g., single-user multiple-input and multiple-output (SU-MIMO), multiple-user multiple-input and multiple-output (MU-MIMO)) and modulation and coding scheme for downlink 106 data transmissions.

There has recently been a lot of interest in coordinated multipoint transmission schemes where multiple transmission points cooperate. There has also been discussion on how to improve the feedback scheme for both coordinated multipoint transmission and multiuser MIMO schemes. One such enhancement for multiuser MIMO was to use a “best-companion” or “worst-companion” precoding matrix indicator (PMI) 110 in addition to the single precoding matrix indicator (PMI) 110 standardized in Rel-8. Benefits may be realized by reducing the number of feedback bits for the “best-companion” or “worst-companion” precoding matrix indicator (PMI) 110.

The eNode B 102 may include multiple received channel state information (CSI) reports 116. Each channel state information (CSI) report 116 may include one or more precoding matrix indicators (PMIs) 120. The channel state information (CSI) reports 116 may be received from one or more user equipments (UEs) 104. An eNode B 102 may receive multiple precoding matrix indicators (PMIs) 120 from a single user equipment (UE) 104. Typically, an eNode B 102 would receive only one precoding matrix indicator (PMI) 110 from each user equipment (UE) 104. However, there have been proposals for a user equipment (UE) 104 to feedback a second precoding matrix indicator (PMI) 110 that includes information on how to further reduce the interference level. This second precoding matrix indicator (PMI) 110 was referred to above as the “best-companion” or “worst-companion” precoding matrix indicator (PMI) 110.

There are many advantages of sending a second precoding matrix indicator (PMI) 110 to an eNode B 102 by a user equipment (UE) 104. However, one of the drawbacks is an increase in the number of feedback bits that are reported from the user equipment (UE) 104 to the eNode B 102. For instance, if N bits of feedback are used for a single precoding matrix indicator (PMI) 110, reporting an additional precoding matrix indicator (PMI) 110 may increase the number of feedback bits to 2N. To reduce the number of feedback bits to less than 2N, a different codebook set 122a-d may be used for the second precoding matrix indicator (PMI) 110 than was used for the first precoding matrix indicator (PMI) 110. In one configuration, the codebook set 122 used for the second precoding matrix indicator (PMI) 110 may vary depending on the first precoding matrix indicator (PMI) 110.

In single-user multiple-input and multiple-output (SU-MIMO), a transmission may be represented using Equation (1):

y=Hx+n. (1)

In Equation (1), y is the received vector Nr×1 (Nr is the number of receive antennas), H is the Nr×Nt channel matrix (Nt is the number of transmit antennas), x is the Nt×1 transmitted signal and n is the Nr×1 noise matrix. Various precoding schemes may be implemented at the transmitter, including singular value decomposition based precoding (SVD) (also referred to as eigen-beamforming). In singular value decomposition based precoding (SVD), any channel matrix can be decomposed into Equation (2):

H=UDV*. (2)

In Equation (2), U and V are unitary matrices, D is a diagonal matrix of singular values and V* is the Hermitian transpose (and inverse) of V. In singular value decomposition based precoding (SVD) or eigen-beamforming, the orthogonal beam directions correspond to the right singular vectors of V. The received data vector with linear precoding can be written according to Equation (3):

y=G(HFx+n). (3)

In Equation (3), G is the postcoder matrix and F is the precoder matrix. Furthermore, assuming a rank 1 transmission, the equivalent channel model after precoding and postcoding for a given data symbol x is given by Equation (4):

y=σ_{max x}+n. (4)

Thus, the user equipment (UE) 104 feeds back a precoding matrix indicator (PMI) 110 to the eNode B 102 that advises the eNode B 102 as to what precoding to apply to the transmit signal to improve the reception by the user equipment (UE) 104. Different criterion (such as maximizing the capacity, minimizing the error probability or maximizing received signal to noise ratio (SNR)) can be used by the user equipment (UE) 104 when determining the precoding matrix indicator (PMI) 110 to feed back to an eNode B 102. In practice, to restrict the number of feedback bits, codebook based precoding is used. In codebook based precoding, the precoding matrix indicator (PMI) 110 is chosen from a set of precoding matrices.

In multiple-user multiple-input and multiple-output (MU-MIMO), the eNode B 102 may communicate with at least a first user equipment (UE) 104a and a second user equipment (UE) 104b. Each of the user equipments (UEs) 104 may include a precoding matrix indicator (PMI) feedback module 112a-b used to determine which precoding matrix indicator(s) (PMI) 110 to feed back to the eNode B 102. For multiple-user multiple-input and multiple-output (MU-MIMO), the received signal at the first user equipment (UE) 104a may be written using Equation (5):

y₁=H₁V₁x₁+H₁V₂x₂+n₁. (5)

The received signal at the second user equipment (UE) 104b may be written using Equation (6):

y₂=H₂V₁x₁+H₂V₂x₂+n₂. (6)

To cancel out the inter user interference completely, Equation (7) needs to be satisfied:

H₁V₂=H₂V₁=0. (7)

In multiple-user multiple-input and multiple-output (MU-MIMO), a user equipment (UE) 104 may feedback both a first precoding matrix indicator (PMI) 110 and a second precoding matrix indicator (PMI) 110. The second precoding matrix indicator (PMI) 110 may be the precoding matrix indicator (PMI) 110 the eNode B 102 should use to pair the user equipment (UE) 104 to minimize the interference to the user equipment (UE) 104. As discussed above, the precoding matrix indicator (PMI) 110 is a recommendation from the user equipment (UE) 104 to the eNode B 102 indicating how the eNode B 102 should precode a transmit signal to the user equipment (UE) 104 to improve the user equipment (UE) 104 reception. For a first user equipment (UE) UE1 104a, the first precoding matrix indicator (PMI) 110 is V1 and the least interfering precoding matrix indicator (PMI) 110 (i.e., the second precoding matrix indicator (PMI) 110) is V2. For a second user equipment (UE) UE2 104b, the first precoding matrix indicator (PMI) 110 is V2 and the least interfering precoding matrix indicator (PMI) 110 is V1. Thus, the first user equipment (UE) UE1 104a and the second user equipment (UE) UE2 104b are paired by the eNode B 102.

Normally, the second precoding matrix indicator (PMI) 110 (i.e., the precoding matrix indicator (PMI) 110 V2 for the first user equipment (UE) UE1 104a) should be chosen from the same set of matrices as the first precoding matrix indicator (PMI) 110. Thus, the second precoding matrix indicator (PMI) 110 uses the same number of bits for feedback as the first precoding matrix indicator (PMI) 110. For example, if the first precoding matrix indicator (PMI) 110 uses N bits of feedback, the total feedback with both the first precoding matrix indicator (PMI) 110 and the second precoding matrix indicator (PMI) 110 would be 2N bits per user equipment (UE) 104. By using a different codebook set 122, which may be a subset of the precoding matrices, for the second precoding matrix indicator (PMI) 110 than for the first precoding matrix indicator (PMI) 110, the total number of bits of feedback may be reduced.

For simplicity, rank 1 transmissions with four transmit antennas at the eNode B 102 are considered. The codebook for downlink transmission may be chosen from Table 1 below. Table 1 is Table 6.3.4.3.4-2 from 3GPP TS 36.211, “Evolved Universal Terrestrial Radio Access (E-UTRA); Physical channels and modulation.”

TABLE 1

| Codebook | | Number of layers υ | | | |
|---|---|---|---|---|---|
| index | uₙ | 1 | 2 | 3 | 4 |
| 0 | u^{₀} = [1 −1 −1 −1]^{T} | W^{₀}_{^{{1}}} | $\frac{{W}_{0}^{\{ 14 \}}}{\sqrt{2}}$ | $\frac{{W}_{0}^{\{ 124 \}}}{\sqrt{3}}$ | $\frac{{W}_{0}^{\{ 1234 \}}}{2}$ |
| 1 | u^{₁} = [1 −j 1 j]^{T} | W^{₁}_{^{{1}}} | $\frac{{W}_{1}^{\{ 12 \}}}{\sqrt{2}}$ | $\frac{{W}_{1}^{\{ 123 \}}}{\sqrt{3}}$ | $\frac{{W}_{1}^{\{ 1234 \}}}{2}$ |
| 2 | u^{₂} = [1 1 −1 1]^{T} | W^{₂}_{^{{1}}} | $\frac{{W}_{2}^{\{ 12 \}}}{\sqrt{2}}$ | $\frac{{W}_{2}^{\{ 123 \}}}{\sqrt{3}}$ | $\frac{{W}_{2}^{\{ 3214 \}}}{2}$ |
| 3 | u^{₃} = [1 j 1 −j]^{T} | W^{₃}_{^{{1}}} | $\frac{{W}_{3}^{\{ 12 \}}}{\sqrt{2}}$ | $\frac{{W}_{3}^{\{ 123 \}}}{\sqrt{3}}$ | $\frac{{W}_{3}^{\{ 3214 \}}}{2}$ |
| 4 | ${u}_{4} = {[ \begin{matrix}1 & \frac{( - 1 - j )}{\sqrt{2}} & - j & \frac{( 1 - j )}{\sqrt{2}}\end{matrix} ]}^{T}$ | W^{₄}_{^{{1}}} | $\frac{{W}_{4}^{\{ 14 \}}}{\sqrt{2}}$ | $\frac{{W}_{4}^{\{ 124 \}}}{\sqrt{3}}$ | $\frac{{W}_{4}^{\{ 1234 \}}}{2}$ |
| 5 | ${u}_{5} = {[ \begin{matrix}1 & \frac{( 1 - j )}{\sqrt{2}} & j & \frac{( - 1 - j )}{\sqrt{2}}\end{matrix} ]}^{T}$ | W^{₅}_{^{{1}}} | $\frac{{W}_{5}^{\{ 14 \}}}{\sqrt{2}}$ | $\frac{{W}_{5}^{\{ 124 \}}}{\sqrt{3}}$ | $\frac{{W}_{5}^{\{ 1234 \}}}{2}$ |
| 6 | ${u}_{6} = {[ \begin{matrix}1 & \frac{( 1 + j )}{\sqrt{2}} & - j & \frac{( - 1 + j )}{\sqrt{2}}\end{matrix} ]}^{T}$ | W^{₆}_{^{{1}}} | $\frac{{W}_{6}^{\{ 13 \}}}{\sqrt{2}}$ | $\frac{{W}_{6}^{\{ 134 \}}}{\sqrt{3}}$ | $\frac{{W}_{6}^{\{ 1324 \}}}{2}$ |
| 7 | ${u}_{7} = {[ \begin{matrix}1 & \frac{( - 1 + j )}{\sqrt{2}} & j & \frac{( 1 + j )}{\sqrt{2}}\end{matrix} ]}^{T}$ | W^{₇}_{^{{1}}} | $\frac{{W}_{7}^{\{ 13 \}}}{\sqrt{2}}$ | $\frac{{W}_{7}^{\{ 134 \}}}{\sqrt{3}}$ | $\frac{{W}_{7}^{\{ 1324 \}}}{2}$ |
| 8 | u^{₈} = [1 −1 1 1]^{T} | W^{₈}_{^{{1}}} | $\frac{{W}_{8}^{\{ 12 \}}}{\sqrt{2}}$ | $\frac{{W}_{8}^{\{ 124 \}}}{\sqrt{3}}$ | $\frac{{W}_{8}^{\{ 1234 \}}}{2}$ |
| 9 | u^{₉} = [1 −j −1 −j]^{T} | W^{₉}_{^{{1}}} | $\frac{{W}_{9}^{\{ 14 \}}}{\sqrt{2}}$ | $\frac{{W}_{9}^{\{ 134 \}}}{\sqrt{3}}$ | $\frac{{W}_{9}^{\{ 1234 \}}}{2}$ |
| 10 | u^{₁₀} = [1 1 1 −1]^{T} | W^{₁₀}_{^{{1}}} | $\frac{{W}_{10}^{\{ 13 \}}}{\sqrt{2}}$ | $\frac{{W}_{10}^{\{ 123 \}}}{\sqrt{3}}$ | $\frac{{W}_{10}^{\{ 1324 \}}}{2}$ |
| 11 | u^{₁₁} = [1 j −1 j]^{T} | W^{₁₁}_{^{{1}}} | $\frac{{W}_{11}^{\{ 13 \}}}{\sqrt{2}}$ | $\frac{{W}_{11}^{\{ 134 \}}}{\sqrt{3}}$ | $\frac{{W}_{11}^{\{ 1324 \}}}{2}$ |
| 12 | u^{₁₂} = [1 −1 −1 1]^{T} | W^{₁₂}_{^{{1}}} | $\frac{{W}_{12}^{\{ 12 \}}}{\sqrt{2}}$ | $\frac{{W}_{12}^{\{ 123 \}}}{\sqrt{3}}$ | $\frac{{W}_{12}^{\{ 1234 \}}}{2}$ |
| 13 | u^{₁₃} = [1 −1 1 −1]^{T} | W^{₁₃}_{^{{1}}} | $\frac{{W}_{13}^{\{ 13 \}}}{\sqrt{2}}$ | $\frac{{W}_{13}^{\{ 123 \}}}{\sqrt{3}}$ | $\frac{{W}_{13}^{\{ 1324 \}}}{2}$ |
| 14 | u^{₁₄} = [1 1 −1 −1]^{T} | W^{₁₄}_{^{{1}}} | $\frac{{W}_{14}^{\{ 13 \}}}{\sqrt{2}}$ | $\frac{{W}_{14}^{\{ 123 \}}}{\sqrt{3}}$ | $\frac{{W}_{14}^{\{ 3214 \}}}{2}$ |
| 15 | u^{₁₅} = [1 1 1 1]^{T} | W^{₁₅}_{^{{1}}} | $\frac{{W}_{15}^{\{ 12 \}}}{\sqrt{2}}$ | $\frac{{W}_{15}^{\{ 123 \}}}{\sqrt{3}}$ | $\frac{{W}_{15}^{\{ 1234 \}}}{2}$ |

For transmission on four antenna ports p E {0, 1, 2, 3}, the precoding matrix W is selected from Table 1 or a subset of Table 1. The quantity Wₙ^{(s)} denotes the matrix defined by the columns given by the set {s} from the expression W_{W}=I−2uₙuₙ^{H}/uₙ^{H}uₙ, where I is the 4×4 identity matrix and the vector uₙ is given by Table 1.

To reduce the number of feedback bits for the second reported precoding matrix indicator (PMI) 110, the set of matrices for the second reported precoding matrix indicator (PMI) 110 may be different from the set of matrices for the first reported precoding matrix indicator (PMI) 110. In one configuration, the second precoding matrix indicator (PMI) 110 may be selected to be orthogonal to the first precoding matrix indicator (PMI) 110 (i.e., <V1,V2>=0, where <x,y> is the inner product between two vectors defined as x^{H} y). Table 2 shows the orthogonal vectors corresponding to each vector from Table 1 above.

TABLE 2

| Codebook | | Codebook indices of |
|---|---|---|
| Index | | orthogonal vectors |
| 0 | u^{₀} = [1 −1 −1 −1]^{T} | 1, 2, 3, 8, 10 |
| 1 | u^{₁} = [1 −j 1 j]^{T} | 0, 2, 3, 9, 11 |
| 2 | u^{₂} = [1 1 −1 1]^{T} | 0, 1, 3, 8, 10 |
| 3 | u^{₃} = [1 j 1 −j]^{T} | 0, 1, 2, 9, 11 |
| 4 | ${u}_{4} = {[ \begin{matrix}1 & \frac{( - 1 - j )}{\sqrt{2}} & - j & \frac{( 1 - j )}{\sqrt{2}}\end{matrix} ]}^{T}$ | 5, 6, 7 |
| 5 | ${u}_{5} = {[ \begin{matrix}1 & \frac{( 1 - j )}{\sqrt{2}} & j & \frac{( - 1 - j )}{\sqrt{2}}\end{matrix} ]}^{T}$ | 4, 6, 7 |
| 6 | ${u}_{6} = {[ \begin{matrix}1 & \frac{( 1 + j )}{\sqrt{2}} & - j & \frac{( - 1 + j )}{\sqrt{2}}\end{matrix} ]}^{T}$ | 4, 5, 7 |
| 7 | ${u}_{7} = {[ \begin{matrix}1 & \frac{( - 1 + j )}{\sqrt{2}} & j & \frac{( 1 + j )}{\sqrt{2}}\end{matrix} ]}^{T}$ | 4, 5, 6 |
| 8 | u^{₈} = [1 −1 1 1]^{T} | 0, 2, 9, 10, 11 |
| 9 | u^{₉} = [1 −j −1 −j]^{T} | 1, 3, 8, 10, 11 |
| 10 | u^{₁₀} = [1 1 1 −1]^{T} | 0, 2, 8, 9, 11 |
| 11 | u^{₁₁} = [1 j −1 j]^{T} | 1, 3, 8, 9, 10 |
| 12 | u^{₁₂} = [1 −1 −1 1]^{T} | 13, 14, 15 |
| 13 | u^{₁₃} = [1 −1 1 −1]^{T} | 12, 13, 15 |
| 14 | u^{₁₄} = [1 1 −1 −1]^{T} | 12, 13, 15 |
| 15 | u^{₁₅} = [1 1 1 1]^{T} | 12, 13, 14 |

For codebook index 0, there are five orthogonal vectors requiring only three bits of feedback for the second precoding matrix indicator (PMI) 110. One example of an application of the systems and methods is given as follows. For a rank 1 transmission (as indicated above, for example), one codeword (out of a possible 16 codewords listed in Table 1, for example) may be chosen or selected. Its corresponding index (given in the first column in Table 1, for example) may be indicated by the first PMI 110. Since 16 codewords may be available, the first PMI may require ceiling(Log₂(16))=4 bits for unambiguous representation, where ceiling(x) is the smallest integer number greater than or equal to x (e.g., ceiling(5.2)=6).

In some configurations, it may be assumed that 0 is the index of the first codeword. For example, the first precoding codeword may be up in Table 1. In Table 1, there are five codewords that are orthogonal to u₀. They may be denoted v1, v2, v3, v4, and v5 and may be arranged in a table similar to Table 1. In order to identify each of them unambiguously, ceiling(Log2(5))=3 bits may be required. It should be noted that each entry in the last column in Table 2 may be the set of indices of the vectors that are orthogonal to the vector in the second column of the same row whose index is on the first column of the same row.

Furthermore, by removing any one entry, only two bits of feedback are required for the second precoding matrix indicator (PMI) 110. For example, if one element is removed from the set of {v1, v2, v3, v4, v5} (e.g., v5), then only ceiling(Log2(4))=2 bits may be required. For codebook index 4, there are only three orthogonal entries requiring two bits of feedback. Depending on the first precoding matrix indicator (PMI) 110, the codebook set 122 for the second precoding matrix indicator (PMI) 110 may be selected appropriately to reduce the number of bits of feedback rather than using the same codebook set 122 (and hence the same number of bits of feedback) as the first precoding matrix indicator (PMI) 110.

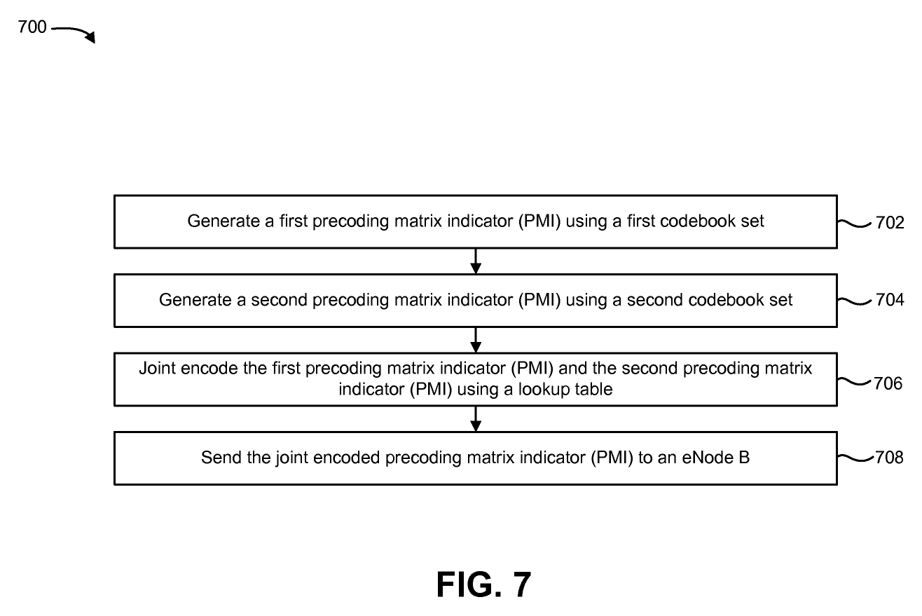

Another way to reduce the number of bits of feedback for a first precoding matrix indicator (PMI) 110 and a second precoding matrix indicator (PMI) 110 is to use joint coding for the first precoding matrix indicator (PMI) 110 and the second precoding matrix indicator (PMI) 110. In joint coding, each entry in Table 2 above may be used to form one or more lookup tables 126, 126a-b. From Table 2, there are 64 different orthogonal vector combinations. Thus, the first precoding matrix indicator (PMI) 110 and the second precoding matrix indicator (PMI) 110 may be jointly encoded using a six bit indicator based on the 64 different orthogonal vector combinations. In the lookup tables 126, 126a-b, the row entry may correspond to the first precoding matrix indicator (PMI) 110 and the column entry may correspond to the second precoding matrix indicator (PMI) 110 or vice-versa. Joint encoding the first precoding matrix indicator (PMI) 110 and the second precoding matrix indicator (PMI) 110 is further discussed below in relation to FIG. 7.

In some configurations, the lookup tables 126a-b may be respectively included in each UE 104a-b (e.g., in each PMI feedback module 112a-b). The lookup tables 126a-b included in each UE 104a-b may be the same as or similar to the lookup table 126 on the eNode B 102. In one example, the first UE 104a may use a lookup table 126a to jointly encode the first PMI 110 and the second PMI 110 that is sent to the eNode B 102. Additionally or alternatively, the eNode B 102 may use the lookup table 126 to interpret (e.g., decode) the jointly encoded first PMI 110 and second PMI 110.

Each UE 104a-b may respectively include a channel quality indicator (CQI) feedback module 132a-b. A channel quality indicator (CQI) feedback module 132 may generate one or more channel quality indicators (CQIs) for transmission to the eNode B 102. For example, a CQI feedback module 132 may generate and send a first CQI corresponding to a first PMI 110 and/or generate and send a second CQI corresponding to a second PMI 110. The eNode B 102 may receive one or more CQIs 128. In some configurations, one or more CQIs 128 may be included in a received channel state information (CSI) report 116.

More specifically, a channel quality indicator (CQI) corresponding to the second PMI 110 may additionally or alternatively be sent in some configurations. It may be possible to represent the second CQI (e.g., the CQI that corresponds to the second PMI) using fewer bits than for the first CQI. Recall equation (3) above, where the transmission and reception operations can be simplified as y=G(HFx+n), where G is used at a receiver and F is the precoding used at a transmitter. The output of an operation (that is described as follows) for a rank 1 transmission is a scalar. For example, y is a real (or possibly a complex) number. The equation may be rewritten similar to the format in equation (4) as y=z+w, where z is a complex number and w is the equivalent of noise after the transmission and reception (G and F) operations. P may be defined to be the power of z, which may be defined as P=ZZ*, where * is the complex conjugate operator. Also, the variance of the equivalent noise w may be denoted by S. Then, the received signal to noise ratio is denoted by SNR and defined by

$$SNR = \frac{P}{S} .$$

A mapping is available to (e.g., stored on) both a UE 104 and eNode B 102 that maps the received SNR to a CQI index. One example of the CQI index is illustrated in Table 3 below. The larger the SNR, the better the channel quality and the larger the corresponding CQI index in Table 3. Assume that the operator G at the receiver is fixed. Further assume that there are two options for transmission precoding, F₁ for a first precoding and F₂ for a second precoding. Denote y₁=G(HF₁x+n) and y₂=G(HF₂x+n). Also respectively denote the SNR corresponding to F₁ and F₂ by SNR₁ and SNR₂ and corresponding CQIs by CQI₁ and CQI₂. Since the first PMI 110 is chosen such that the corresponding CQI is the largest, then CQI₁>CQI₂ regardless of the choice of F₂. Therefore, CQI₁>CQI₂ in particular when the second precoding vector is chosen from a set of vectors (matrices) that are orthogonal to the first precoding vector (matrix).

In one example, a CQI table may have 16 values as illustrated in Table 3 below. A first CQI corresponding to the first PMI 110 may have a value (e.g., CQI₁). A second CQI corresponding to second PMI 110 may have a value (e.g., CQI₂) that is smaller than CQI₁. Therefore, it may be possible to represent CQI₂ with a smaller number of bits than are needed to represent CQI₁. In one configuration, ceiling(Log₂(16))=4 bits may be required to represent CQI₁.

One approach to represent CQI₂ with a smaller number of bits may be to partition the CQI values smaller than CQI₁. The partitioning may depend on the value of CQI₁. In one configuration, a UE 104 may send the value of CQI₁ to the eNode B 102. The eNode B 102 may regenerate the partitioning. One example of partitioning (or repartitioning) is to have CQI₂ take values in a set {0, 1, 2, >3}. In this case, only two bits of feedback may be needed to represent CQI₂, since the set has four members and two bits may be used to represent four cases unambiguously.

This may be referred to as enhanced channel quality indicator (CQI) feedback for multiple-user multiple-input and multiple-output (MU-MIMO). The channel quality indicator (CQI) 128 indices and their interpretations are given in Table 3 below.

TABLE 3

| | | code rate x | |
|---|---|---|---|
| CQI index | modulation | 1024 | efficiency |

| | |
|---|---|
| 0 | out of range |

| | | | |
|---|---|---|---|
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

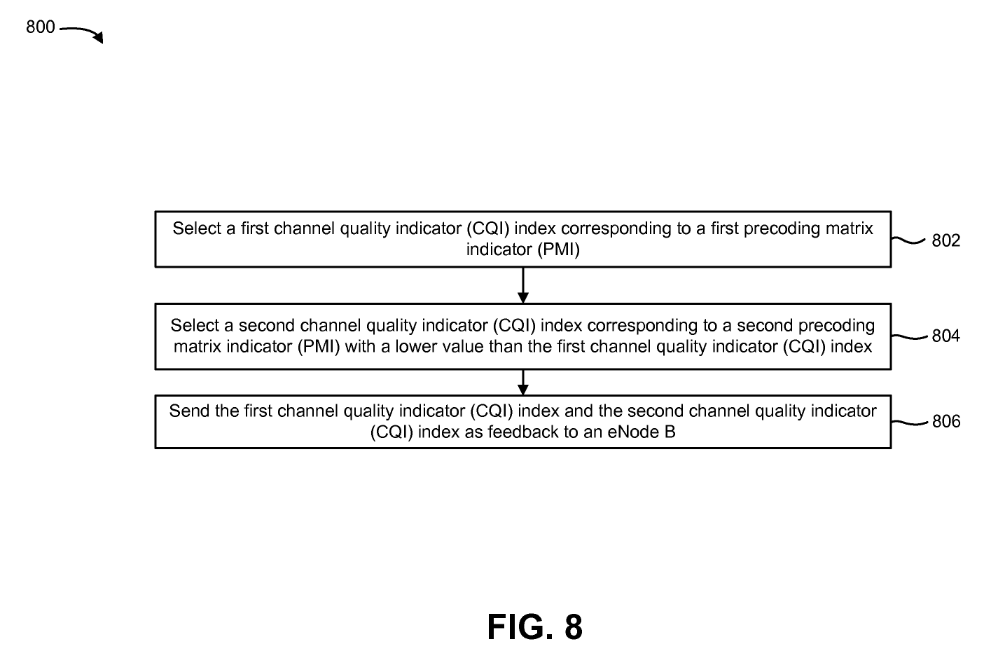

For the first precoding matrix indicator (PMI) 110, the channel quality indicator (CQI) 128 index may be any of the 16 indices from Table 3 (i.e., a 4 bit indicator). The channel quality indicator (CQI) 128 corresponding to the second precoding matrix indicator (PMI) 110 is less than (e.g., has a lower value than) the channel quality indicator (CQI) 128 index used for the first precoding matrix indicator (PMI) 110. Depending on the channel quality indicator (CQI) 128 index used for the first precoding matrix indicator (PMI) 110, the channel quality indicator (CQI) 128 set may be partitioned into regions for each precoding matrix indicator (PMI) 110. One partition would be to use the channel quality indicator (CQI) 128 index set to be {0, 1, 2, 3}, thus requiring only 2 bits of feedback. Using a channel quality indicator (CQI) 128 corresponding to each precoding matrix indicator (PMI) 110 is further discussed below in relation to FIG. 8.

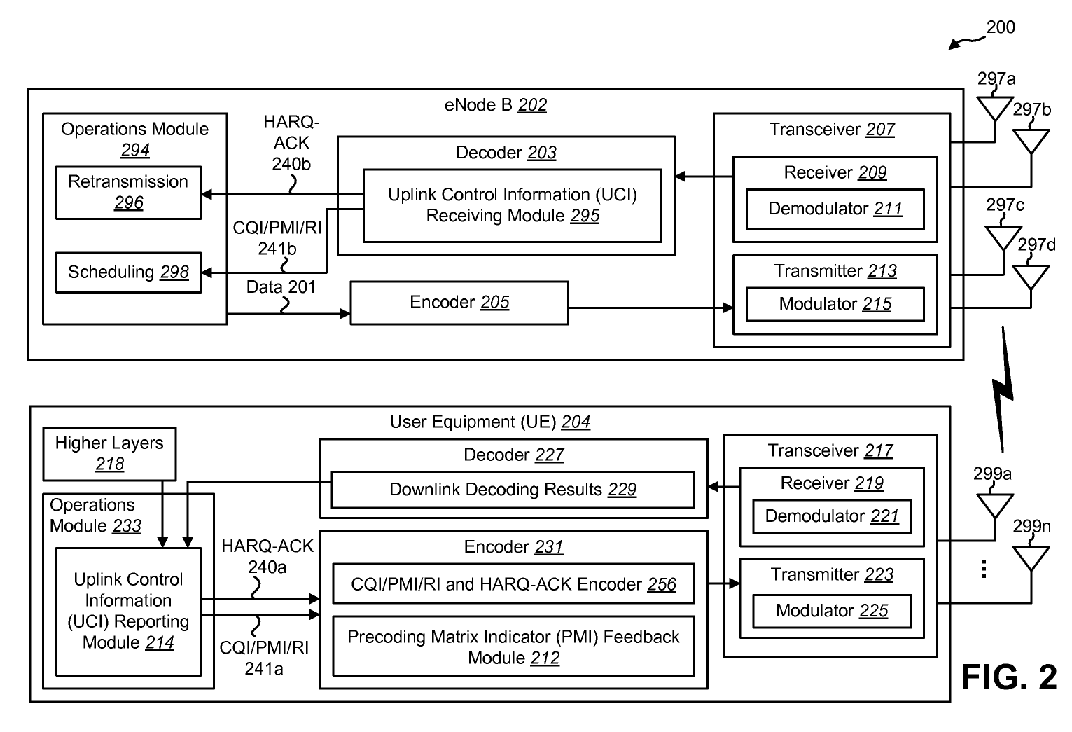

FIG. 2 is a block diagram illustrating a wireless communication system 200 using uplink control information (UCI) multiplexing. An eNode B 202 may be in wireless communication with one or more user equipments (UEs) 204. The eNode B 202 of FIG. 2 may be one configuration of the eNode B 102 of FIG. 1. The user equipment (UE) 204 of FIG. 2 may be one configuration of the user equipments (UEs) 104a-b of FIG. 1.

The user equipment (UE) 204 communicates with the eNode B 202 using one or more antennas 299a-n. The user equipment (UE) 204 may include a transceiver 217, a decoder 227, an encoder 231 and an operations module 233. The transceiver 217 may include a receiver 219 and a transmitter 223. The receiver 219 may receive signals from the eNode B 202 using one or more antennas 299a-n. For example, the receiver 219 may receive and demodulate received signals using a demodulator 221. The transmitter 223 may transmit signals to the eNode B 202 using one or more antennas 299a-n. For example, the transmitter 223 may modulate signals using a modulator 225 and transmit the modulated signals.

The receiver 219 may provide a demodulated signal to the decoder 227. The user equipment (UE) 204 may use the decoder 227 to decode signals and make downlink decoding results 229. The downlink decoding results 229 may indicate whether data was received correctly. For example, the downlink decoding results 229 may indicate whether a packet was correctly or erroneously received (i.e., positive acknowledgement, negative acknowledgement or discontinuous transmission (no signal)).

The operations module 233 may be a software and/or hardware module used to control user equipment (UE) 204 communications. For example, the operations module 233 may determine when the user equipment (UE) 204 requires resources to communicate with an eNode B 202. The operations module 233 may receive instructions from higher layers 218.

The user equipment (UE) 204 may transmit control information to the eNode B 202. For example, both the hybrid automatic repeat and request (ARQ) acknowledgement (HARQ-ACK) 240a with positive-acknowledge and negative-acknowledge (ACK/NACK) bits and other control information may be transmitted using the physical uplink control channel (PUCCH) and/or the physical uplink shared channel (PUSCH).

The user equipment (UE) 204 may transmit uplink control information (UCI) to an eNode B 202 on the uplink. The uplink control information (UCI) may include a channel quality indicator (CQI) 128, a precoding matrix indicator (PMI) 110, rank indication (RI), a scheduling request (SR) and a hybrid automatic repeat request acknowledgement (HARQ-ACK) 240a. HARQ-ACK 240a means ACK (positive-acknowledgement) and/or NACK (negative-acknowledgement) and/or DTX (discontinuous transmission) responses for HARQ operation, also known as ACK/NACK. If a transmission is successful, the HARQ-ACK 240a may have a logical value of 1 and if the transmission is unsuccessful, the HARQ-ACK 240a may have a logical value of 0. The channel quality indicator (CQI) 128, precoding matrix indicator (PMI) 110 and rank indication (RI) may collectively be referred to as CQI/PMI/RI 241a. CQI/PMI/RI 241 may refer to CQI and/or PMI and/or RI.

The uplink control information (UCI) may be transmitted on either the physical uplink control channel (PUCCH) or the physical uplink shared channel (PUSCH). The uplink control information (UCI) 241a may be reported from a user equipment (UE) 204 to an eNode B 202 either periodically or a periodically.

The HARQ-ACK 240a and the CQI/PMI/RI 241a may be generated by the uplink control information (UCI) reporting module 214 and transferred to an encoder 231. The encoder 231 may generate uplink control information (UCI) using backwards compatible physical uplink control channel (PUCCH) formats and physical uplink shared channel (PUSCH) formats. Backwards compatible physical uplink control channel (PUCCH) formats are those formats that may be used by Release-10 user equipments (UEs) 204 as well as Release-8/9 user equipments (UEs) 204.

The time and frequency resources may be quantized to create a grid known as the Time-Frequency grid. In the time domain, 10 milliseconds (ms) is referred to as one radio frame. One radio frame may include 10 subframes, each with a duration of 1 ms, which is the duration of transmission in the uplink and/or downlink. Every subframe may be divided into two slots, each with a duration of 0.5 ms. Each slot may be divided into seven symbols. The frequency domain may be divided into bands with a 15 kilohertz (kHz) width, referred to as a subcarrier. One resource element has a duration of one symbol in the time domain and the bandwidth of one subcarrier in the frequency domain.

The minimum amount of resource that can be allocated for the transmission of information in the uplink or downlink in any given subframe is two resource blocks (RBs), one RB at each slot. One RB has a duration of 0.5 ms (seven symbols or one slot) in the time domain and a bandwidth of 12 subcarriers (180 kHz) in the frequency domain. At any given subframe, a maximum of two RBs (one RB at each slot) can be used by a given user equipment (UE) 204 for the transmission of uplink control information (UCI) in the physical uplink control channel (PUCCH).

In some configurations, the encoder 231 may include a CQI/PMI/RI and HARQ-ACK encoder 256. The CQI/PMI/RI and HARQ-ACK encoder 256 may encode the CQI/PMI/RI 241a and/or HARQ-ACK 240a for transmission. In one example, the CQI/PMI/RI and HARQ-ACK encoder 256 may use one or more of the formats described above for encoding the CQI/PMI/RI 241a and/or HARQ-ACK 240a.

In some configurations, the encoder 231 may include a precoding matrix indicator (PMI) feedback module 212. In one example, the precoding matrix indicator (PMI) feedback module 212 may operate similarly to one or more of the precoding matrix indicator (PMI) feedback modules 112a-b described above in connection with FIG. 1.

An eNode B 202 may include a transceiver 207 that includes a receiver 209 and a transmitter 213. An eNode B 202 may additionally include a decoder 203, an encoder 205 and an operations module 294. An eNode B 202 may receive uplink control information (UCI) using four antennas 297a-d and its receiver 209. The receiver 209 may use the demodulator 211 to demodulate the uplink control information (UCI).

The decoder 203 may include an uplink control information (UCI) receiving module 295. An eNode B 202 may use the uplink control information (UCI) receiving module 295 to decode and interpret the uplink control information (UCI) received by the eNode B 202. The eNode B 202 may use the decoded uplink control information (UCI) to perform certain operations, such as retransmit one or more packets based on scheduled communication resources for the user equipment (UE) 204. The uplink control information (UCI) may include a CQI/PMI/RI 241b and/or an HARQ-ACK 240b.

The operations module 294 may include a retransmission module 296 and a scheduling module 298. The retransmission module 296 may determine which packets to retransmit (if any) based on the uplink control information (UCI). The scheduling module 298 may be used by the eNode B 202 to schedule communication resources (e.g., bandwidth, time slots, frequency channels, spatial channels, etc.). The scheduling module 298 may use the uplink control information (UCI) to determine whether (and when) to schedule communication resources for the user equipment (UE) 204.

The operations module 294 may provide data 201 to the encoder 205. For example, the data 201 may include packets for retransmission and/or a scheduling grant for the user equipment (UE) 204. The encoder 205 may encode the data 201, which may then be provided to the transmitter 213. The transmitter 213 may modulate the encoded data using the modulator 215. The transmitter 213 may transmit the modulated data to the user equipment (UE) 204 using the antennas 297a-d.

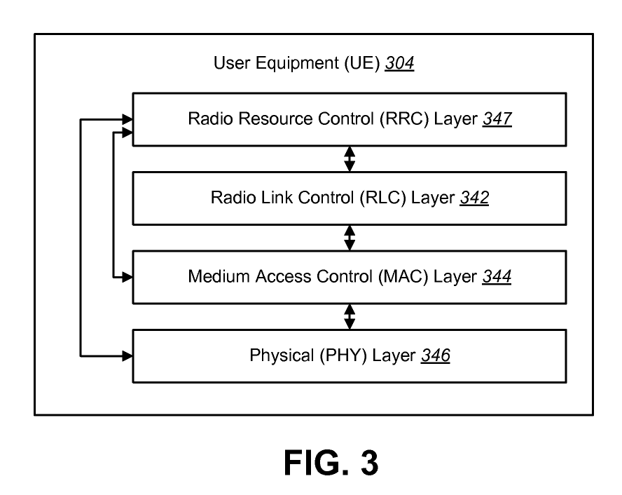

FIG. 3 is a block diagram illustrating the layers used by a user equipment (UE) 304. The user equipment (UE) 304 of FIG. 3 may be one configuration of the user equipments (UEs) 104a-b of FIG. 1. The user equipment (UE) 304 may include a radio resource control (RRC) layer 347, a radio link control (RLC) layer 342, a medium access control (MAC) layer 344 and a physical (PHY) layer 346. These layers may be referred to as higher layers 218. The user equipment (UE) 304 may include additional layers not shown in FIG. 3.

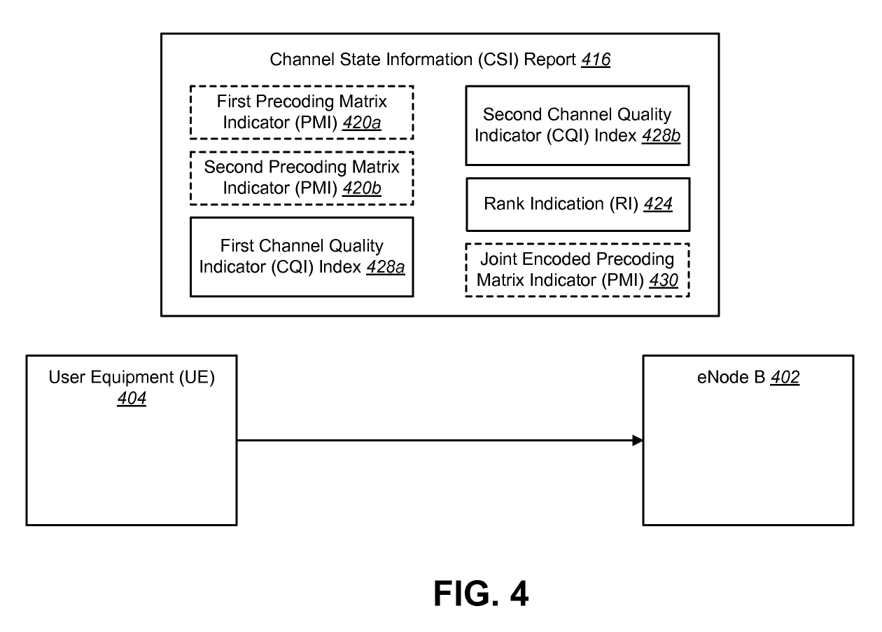

FIG. 4 is a block diagram illustrating examples of channel state information (CSI) content of uplink control information (UCI). The user equipment (UE) 404 may transmit a channel state information (CSI) report 416 to the eNode B 402. The channel state information (CSI) report 416 may include a first precoding matrix indicator (PMI) 420a (also referred to as a primary precoding matrix indicator (PMI) 110), a second precoding matrix indicator (PMI) 420b (also referred to as an enhanced precoding matrix indicator (PMI) 110), a first channel quality indicator (CQI) index 428a, a second channel quality indicator (CQI) index 428b and a rank indication (RI) 424. The user equipment (UE) 404 may transmit the channel state information (CSI) report 416 using the physical uplink shared channel (PUSCH) or the physical uplink control channel (PUCCH). In one configuration, the user equipment (UE) 404 may simultaneously transmit a physical uplink control channel (PUCCH) symbol and a physical uplink shared channel (PUSCH) symbol to the eNode B 402. The information in the channel state information (CSI) report 416 may be referred to as uplink control information (UCI).

In some configurations, the channel state information (CSI) report 416 may include a joint encoded precoding matrix indicator (PMI) 430. The joint encoded precoding matrix indicator (PMI) 430 may be sent alternatively from (e.g., instead of) the first precoding matrix indicator (PMI) 420a and the second precoding matrix indicator (PMI) 420b. More specifically, the channel state information (CSI) report 416 may include either the joint encoded precoding matrix indicator (PMI) 430 or the first and second precoding matrix indicators 420a-b.

For instance, the UE 404 may jointly encode a first precoding matrix indicator (PMI) and a second precoding matrix indicator (PMI) using a lookup table in one configuration. As discussed above, the lookup table may match the codebook indices of orthogonal vectors. The user equipment (UE) 404 may then send the joint encoded precoding matrix indicator (PMI) 430 to an eNode B 402.

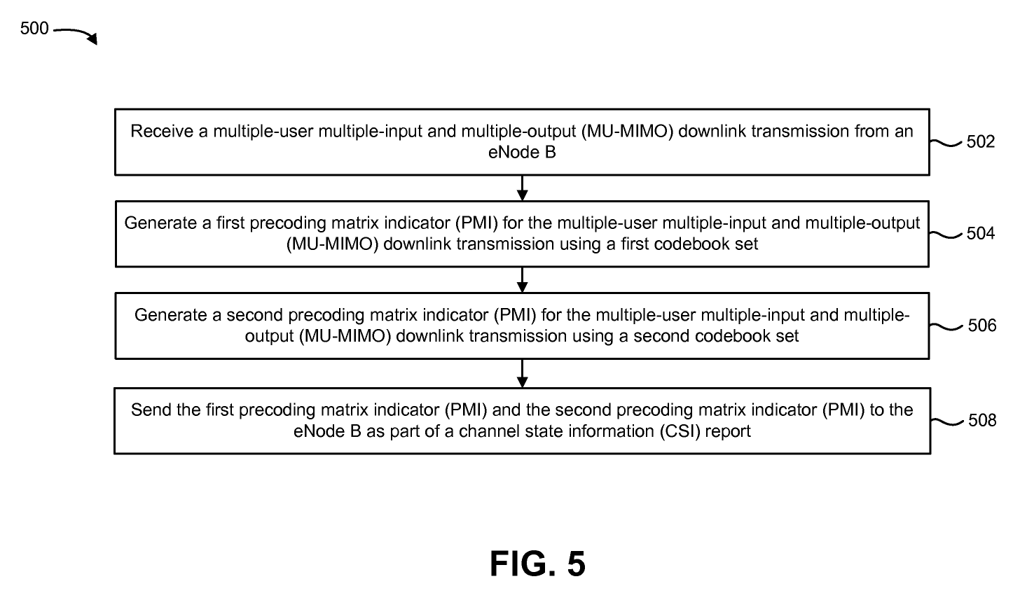

FIG. 5 is a flow diagram of a method 500 for reporting uplink control information (UCI). The method 500 may be performed by a user equipment (UE) 104. The method 500 may reduce the number of feedback bits used for the uplink control information (UCI). The user equipment (UE) 104 may receive 502 a multiple-user multiple-input and multiple-output (MU-MIMO) downlink transmission from an eNode B 102. In response to the multiple-user multiple-input and multiple-output (MU-MIMO) downlink transmission, the user equipment (UE) 104 may generate uplink control information (UCI). The uplink control information (UCI) may include a first precoding matrix indicator (PMI) 420a and a second precoding matrix indicator (PMI) 420b.

The user equipment (UE) 104 may generate 504 a first precoding matrix indicator (PMI) 420a for the multiple-user multiple-input and multiple-output (MU-MIMO) downlink transmission using a first codebook set 122. For example, the user equipment (UE) 104 may select a first precoding matrix from the first codebook set 122. The index of the first selected precoding matrix may be the first precoding matrix indicator (PMI) 420a. It should be noted that the first codebook set 122 (e.g., first codebook, first precoding set) may be known to both the UE 104 and the eNode B 102. For example, the UE 104 may include (e.g., store) the first codebook set 122 and the eNode B 102 may include (e.g., store) a similar first codebook set.

The user equipment (UE) 104 may also generate 506 a second precoding matrix indicator (PMI) 420b for the multiple-user multiple-input and multiple-output (MU-MIMO) downlink transmission using a second codebook set 122. For example, the user equipment (UE) 104 may generate the second codebook set 122 (e.g., second codebook or second precoding set) based on the selected first precoding matrix. This may be accomplished as described in connection with FIG. 1 above. The UE 104 may select a second precoding matrix from the second codebook set 122. The index of the second precoding matrix may be the second precoding matrix indicator (PMI) 420b.

The user equipment (UE) 104 may then send 508 the first precoding matrix indicator (PMI) 420a and the second precoding matrix indicator (PMI) 420b to the eNode B 102 as part of a channel state information (CSI) report 416.

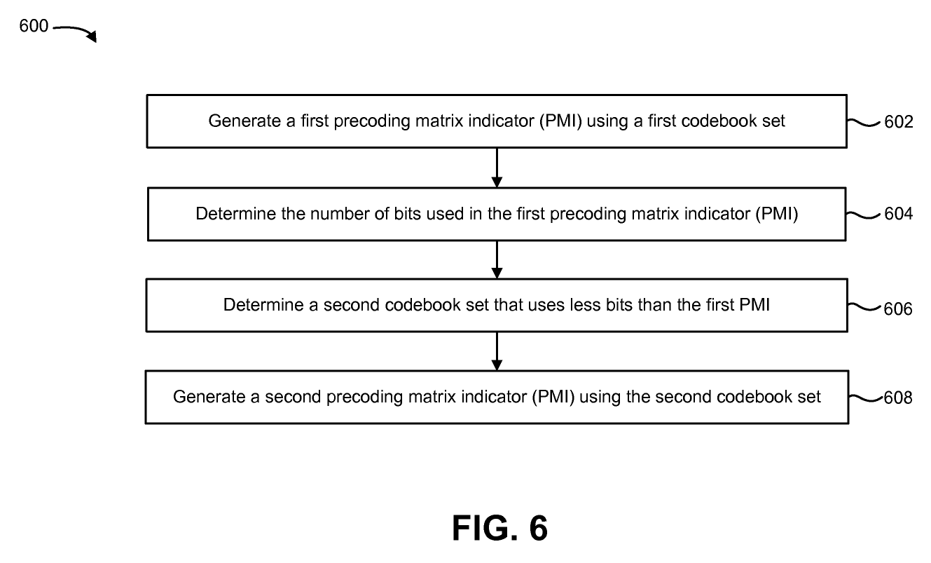

FIG. 6 is a flow diagram of another method 600 for reporting uplink control information (UCI). The method 600 may be performed by a user equipment (UE) 104. The method 600 may reduce the number of feedback bits in the uplink control information (UCI). The user equipment (UE) 104 may generate 602 a first precoding matrix indicator (PMI) 420a using a first codebook set 122. The user equipment (UE) 104 may determine 604 the number of bits used in the first precoding matrix indicator (PMI) 420a. The user equipment (UE) 104 may then determine 606 a second codebook set 122 that uses less bits than the first precoding matrix indicator (PMI) 420a (e.g., fewer bits than the first codebook set 122). The user equipment (UE) 104 may generate 608 a second precoding matrix indicator (PMI) 420b using the second codebook set 122.

FIG. 7 is a flow diagram of method 700 for reducing the number of feedback bits in uplink control information (UCI) using joint encoding. Joint encoding was discussed above in relation to FIG. 1. The method 700 may be performed by a user equipment (UE) 104. The user equipment (UE) 104 may generate 702 a first precoding matrix indicator (PMI) 420a using a first codebook set 122. The user equipment (UE) 104 may generate 704 a second precoding matrix indicator (PMI) 420b using a second codebook set 122. The user equipment (UE) 104 may joint encode 706 the first precoding matrix indicator (PMI) 420a and the second precoding matrix indicator (PMI) 420b using a lookup table 126. As discussed above, the lookup table 126 may match the codebook indices of orthogonal vectors. The user equipment (UE) 104 may then send 708 the joint encoded precoding matrix indicator (PMI) 430 to an eNode B 102.

FIG. 8 is a flow diagram of a method 800 for reducing the number of feedback bits in uplink control information (UCI) using enhanced channel quality indicator (CQI) 128 feedback for multiple-user multiple-input and multiple-output (MU-MIMO). Enhanced channel quality indicator (CQI) 128 feedback for multiple-user multiple-input and multiple-output (MU-MIMO) was discussed above in relation to FIG. 1. The method 800 may be performed by a user equipment (UE) 104. The user equipment (UE) 104 may select 802 a first channel quality indicator (CQI) index 428a corresponding to a first precoding matrix indicator (PMI) 420a. The channel quality indicator (CQI) indices 428 and their interpretations were given above in Table 3.

The user equipment (UE) 104 may select 804 a second channel quality indicator (CQI) index 428b corresponding to a second precoding matrix indicator (PMI) 420b with a lower value than the first channel quality indicator (CQI) index 428a. The second CQI index 428b may have a lower value than the first CQI index 428a as described above in connection with FIG. 1. Using a lower value for the second CQI index 428b may allow the UE 104 to represent it 428b using fewer bits than are used for the first CQI index 428a. In some configurations, this may be done using partitioning as described above in connection with FIG. 1. The user equipment (UE) 104 may send 806 the first channel quality indicator (CQI) index 428a and the second channel quality indicator (CQI) index 428b as feedback to an eNode B 102.

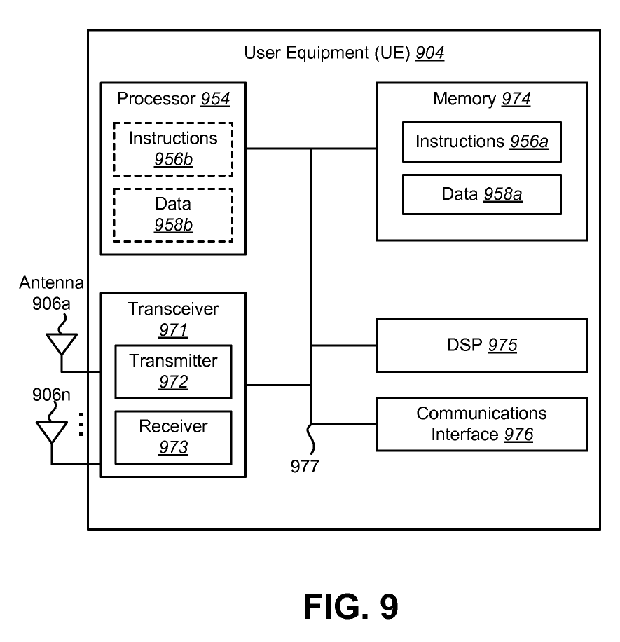

FIG. 9 illustrates various components that may be utilized in a user equipment (UE) 904. The user equipment (UE) 904 may be utilized as the user equipment (UE) 104 illustrated previously. The user equipment (UE) 904 includes a processor 954 that controls operation of the user equipment (UE) 904. The processor 954 may also be referred to as a CPU. Memory 974, which may include both read-only memory (ROM), random access memory (RAM) or any type of device that may store information, provides instructions 956a and data 958a to the processor 954. A portion of the memory 974 may also include non-volatile random access memory (NVRAM). Instructions 956b and data 958b may also reside in the processor 954. Instructions 956b and/or data 958b loaded into the processor 954 may also include instructions 956a and/or data 958a from memory 974 that were loaded for execution or processing by the processor 954. The instructions 956b may be executed by the processor 954 to implement the systems and methods disclosed herein.

The user equipment (UE) 904 may also include a housing that contains a transmitter 972 and a receiver 973 to allow transmission and reception of data. The transmitter 972 and receiver 973 may be combined into a transceiver 971. One or more antennas 906a-n are attached to the housing and electrically coupled to the transceiver 971.

The various components of the user equipment (UE) 904 are coupled together by a bus system 977, which may include a power bus, a control signal bus, and a status signal bus, in addition to a data bus. However, for the sake of clarity, the various buses are illustrated in FIG. 9 as the bus system 977. The user equipment (UE) 904 may also include a digital signal processor (DSP) 975 for use in processing signals. The user equipment (UE) 904 may also include a communications interface 976 that provides user access to the functions of the user equipment (UE) 904. The user equipment (UE) 904 illustrated in FIG. 9 is a functional block diagram rather than a listing of specific components.

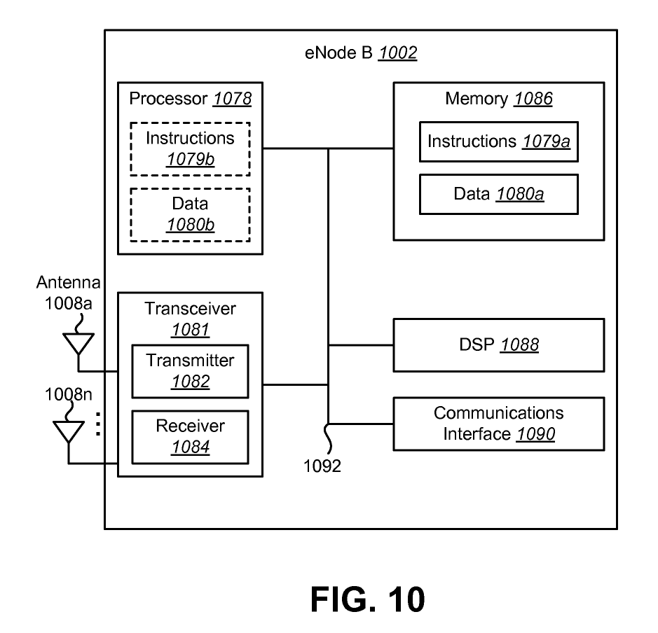

FIG. 10 illustrates various components that may be utilized in an eNode B 1002. The eNode B 1002 may be utilized as the eNode B 102 illustrated previously. The eNode B 1002 may include components that are similar to the components discussed above in relation to the user equipment (UE) 904, including a processor 1078, memory 1086 that provides instructions 1079a and data 1080a to the processor 1078, instructions 1079b and data 1080b that may reside in or be loaded into the processor 1078, a housing that contains a transmitter 1082 and a receiver 1084 (which may be combined into a transceiver 1081), one or more antennas 1008a-n electrically coupled to the transceiver 1081, a bus system 1092, a DSP 1088 for use in processing signals, a communications interface 1090 and so forth.

Unless otherwise noted, the use of ‘/’ above represents the phrase “and/or.”

The functions described herein may be implemented in hardware, software, firmware or any combination thereof. If implemented in software, the functions may be stored as one or more instructions on a computer-readable medium. The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

As used herein, the term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory may be integral to a processor and still be said to be in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

Software or instructions may also be transmitted over a transmission medium. For example, if the software is transmitted from a website, server, or other remote source using a coaxial cable, fiber optic cable, twisted pair, digital subscriber line (DSL) or wireless technologies such as infrared, radio, and microwave, then the coaxial cable, fiber optic cable, twisted pair, DSL, or wireless technologies such as infrared, radio and microwave are included in the definition of transmission medium.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for reporting uplink control information (UCI) on a user equipment (UE), comprising:
generating a first precoding matrix indicator (PMI) corresponding to a multiple-user multiple-input and multiple-output (MU-MIMO) downlink transmission using a first codebook set;
generating a second PMI corresponding to the MU-MIMO downlink transmission using a second codebook set; and
sending the first PMI and the second PMI to an eNode B in a channel state information (CSI) report.

2. The method of claim 1, further comprising receiving the MU-MIMO downlink transmission from the eNode B.

3. The method of claim 1, wherein the second PMI uses less feedback bits than the first PMI.

4. The method of claim 1, wherein the first codebook set and the second codebook set are orthogonal to each other.

5. The method of claim 1, wherein the first PMI and the second PMI are orthogonal to each other.

6. The method of claim 1, further comprising:
determining a number of bits used in the first PMI; and
determining a second codebook set that uses less bits than the number of bits used in the first PMI.

7. The method of claim 1, further comprising joint encoding the first PMI and the second PMI using a lookup table, and wherein sending the first PMI and the second PMI to an eNode B in a CSI report comprises sending the joint encoded PMI to the eNode B.

8. The method of claim 7, wherein a row entity in the lookup table corresponds to the first PMI and a column entity in the lookup table corresponds to the second PMI.

9. The method of claim 1, further comprising:
selecting a first channel quality indicator (CQI) index corresponding to the first PMI; and
selecting a second CQI index corresponding to the second PMI with a lower value than the first CQI index, wherein sending the first PMI and the second PMI to an eNode B in a CSI report comprises sending the first CQI index and the second CQI index to the eNode B.

10. The method of claim 9, wherein the second CQI index is represented with a smaller number of bits than the first CQI index using partitioning.

11. A user equipment (UE) configured for reporting uplink control information (UCI), comprising:
a processor;
memory in electronic communication with the processor;
instructions stored in the memory, the instructions being executable to:
generate a first precoding matrix indicator (PMI) corresponding to a multiple-user multiple-input and multiple-output (MU-MIMO) downlink transmission using a first codebook set;
generate a second PMI corresponding to the MU-MIMO downlink transmission using a second codebook set; and
send the first PMI and the second PMI to an eNode B in a channel state information (CSI) report.

12. The UE of claim 11, wherein the instructions are further executable to receive the MU-MIMO downlink transmission from the eNode B.

13. The UE of claim 11, wherein the second PMI uses less feedback bits than the first PMI.

14. The UE of claim 11, wherein the first codebook set and the second codebook set are orthogonal to each other.

15. The UE of claim 11, wherein the first PMI and the second PMI are orthogonal to each other.

16. The UE of claim 11, wherein the instructions are further executable to:
determine a number of bits used in the first PMI; and
determine a second codebook set that uses less bits than the number of bits used in the first PMI.

17. The UE of claim 11, wherein the instructions are further executable to joint encode the first PMI and the second PMI using a lookup table, and wherein the instructions executable to send the first PMI and the second PMI to an eNode B in a CSI report comprise instructions executable to send the joint encoded PMI to the eNode B.

18. The UE of claim 17, wherein a row entity in the lookup table corresponds to the first PMI and a column entity in the lookup table corresponds to the second PMI.

19. The UE of claim 11, wherein the instructions are further executable to:
select a first channel quality indicator (CQI) index corresponding to the first PMI; and
select a second CQI index corresponding to the second PMI with a lower value than the first CQI index, wherein the instructions executable to send the first PMI and the second PMI to an eNode B in a CSI report comprise instructions executable to send the first CQI index and the second CQI index to the eNode B.

20. The UE of claim 19, wherein the second CQI index is represented with a smaller number of bits than the first CQI index using partitioning.
